(19) United States
(12) Patent Application Publication
(10) Pub. No.: US 2018/0285434 A1
(43) Pub. Date: Oct. 4, 2018

(54) CLOUD-TO-LOCAL, LOCAL-TO-CLOUD SWITCHING AND SYNCHRONIZATION OF MEDICAL IMAGES AND DATA

(71) Applicant: Konica Minolta Healthcare Americas, Inc., Wayne, NJ (US)

(72) Inventors: Takao Shiibashi, Wayne, NJ (US); Takayuki Ishikawa, Wayne, NJ (US)

(73) Assignee: Konica Minolta Healthcare Americas, Inc., Wayne, NJ (US)

(21) Appl. No.: 15/476,087

(22) Filed: Mar. 31, 2017

(51) Int. Cl. G06F 17/30; G06F 19/00

(52) U.S. Cl. CPC G06F 17/30575; G06F 19/321

(57) ABSTRACT

A method to prevent conflict during synchronization of medical data between a cloud repository on a cloud server and a plurality of local repositories on a plurality of local servers of healthcare facilities connected to the cloud server is provided. The plurality of local servers includes a first local server and the plurality of local repositories includes a first local repository on the first local server. The method includes, while a connection between the first local server and the cloud server is established, causing the first local server to: receive remote data from the cloud repository; store the remote data in the first local repository as local data; and in response to the connection between the first local server and the cloud server getting disconnected, causing the first local server to: access the first local repository instead of the cloud repository; and restrict editing on the first local repository.

### BACKGROUND

Medical images and medical data play a crucial role in the diagnosis of a patient. Healthcare facilities (e.g., hospitals) have realized the benefits of electronically storing medical images and medical data. The digitalization of the medical images and data not only enables users to easily access medical images and medical data, but also enables the images and data to be easily shared between multiple healthcare facilities.

In the healthcare industry, the use of a system known as a Picture Archiving and Communications System (“PACS”) is becoming increasing popular for convenient storage and access of medical images. Generally, PACS comprises a multitude of devices working cooperatively to digitally capture, store, manage, distribute, and display medical images generated by various imaging modalities, such as computed tomography (CT), magnetic resonance imaging (MRI), position emission tomography (PET), ultrasound, X-ray, etc. PACS allows various healthcare facilities to share all types of images captured internally or externally.

More recently, cloud-based PACS have emerged as a way to improve efficiency and accessibility of traditional PACS. In general, a “cloud” can be understood as an online storage system that provides remote, on-demand access of computing resources and data over the Internet to multiple computers and devices in various locations. Cloud-based PACS may be provided by vendors who use remote or off-site data centers in various locations for storage of medical images.

### SUMMARY

In general, in one aspect, the invention relates to a method to prevent conflict during synchronization of medical data between a cloud repository on a cloud server and a plurality of local repositories on a plurality of local servers of healthcare facilities connected to the cloud server. The plurality of local servers comprises a first local server and the plurality of local repositories comprises a first local repository on the first local server. The method comprises: while a connection between the first local server and the cloud server is established, causing the first local server to: receive, from the cloud repository, remote data sent from any of the plurality of local servers to the cloud repository, store the remote data in the first local repository as local data, and if the first local server determines that the remote data is being updated by any of the plurality of local servers, restrict an editing that can be performed on the local data; and in response to the connection between the first local server and the cloud server getting disconnected, causing the first local server to: access the first local repository instead of the cloud repository; and restrict editing on the first local repository.

In general, in one aspect, the invention relates to a non-transitory computer-readable medium (CRM) storing instructions that cause a first local server coupled to a computer to perform an operation to prevent conflict during synchronization of medical data between a cloud repository on a cloud server and a plurality of local repositories on a plurality of local servers of healthcare facilities connected to the cloud server. The plurality of local servers comprises the first local server and the plurality of local repositories comprises a first local repository on the first local serve. The operation comprises: while a connection between the first local server and the cloud server is established, causing the first local server to: receive, from the cloud repository, remote data sent from any of the plurality of local servers to the cloud repository, store the remote data in the first local repository as local data, and if the first local server determines that the remote data is being updated by any of the plurality of local servers, restrict an editing that can be performed on the local data; and in response to the connection between the first local server and the cloud server getting disconnected, causing the first local server to: access the first local repository instead of the cloud repository; and restrict editing on the first local repository.

In general, in one aspect, the invention relates to a system that prevents conflict during synchronization of medical data. The system comprises: a cloud server, a cloud repository on the cloud server; and a plurality of local repositories on a plurality of local servers of healthcare facilities connected to the cloud server, wherein the plurality of local servers comprises a first local server and the plurality of local repositories comprises a first local repository on the first local serve. While a connection between the first local server and the cloud server is established, causing the first local server to: receive, from the cloud repository, remote data sent from any of the plurality of local servers to the cloud repository, store the remote data in the first local repository as local data, and if the first local server determines that the remote data is being updated by any of the plurality of local servers, restrict an editing that can be performed on the local data; and in response to the connection between the first local server and the cloud server getting disconnected, causing the first local server to: access the first local repository instead of the cloud repository; and restrict editing on the first local repository.

Other aspects and advantages of the invention will be apparent from the following description and the appended claims.

### BRIEF DESCRIPTION OF DRAWINGS

FIGS. 1A and 1B show a system in accordance with one or more embodiments.

FIGS. 2A and 2B show a display message in accordance with one or more embodiments.

FIG. 3 shows a data table in accordance with one or more embodiments.

FIG. 4 shows a state of the system of FIGS. 1A and 1B in accordance with one or more embodiments.

FIG. 5 shows a state of the system of FIGS. 1A and 1B in accordance with one or more embodiments.

FIG. 6 shows a state of the system of FIGS. 1A and 1B in accordance with one or more embodiments.

FIG. 7 shows a state of the system of FIGS. 1A and 1B in accordance with one or more embodiments.

FIG. 8 shows a computing system in accordance with one or more embodiments.

FIG. 9 shows a schematic diagram in accordance with one or more embodiments.

FIGS. 10A and 10B show a flowchart in accordance with one or more embodiments.

FIGS. 11A, 11B, and 11C show an implementation example in accordance with one or more embodiments.

FIG. 12 shows a flowchart in accordance with one or more embodiments.

### DETAILED DESCRIPTION

Specific embodiments will now be described in detail with reference to the accompanying figures. Like elements in the various figures are denoted by like reference numerals for consistency. Like elements may not be labeled in all figures for the sake of simplicity.

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers does not imply or create a particular ordering of the elements or limit any element to being only a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “a horizontal beam” includes reference to one or more of such beams.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that, one or more of the steps shown in the flowcharts may be omitted, repeated, and/or performed in a different order than the order shown. Accordingly, the scope of the invention should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

In general, one or more embodiments of the invention provide a method, a non-transitory computer readable medium, and a system configured for cloud-to-local, local-to-cloud switching and synchronization of medical images and data with a mechanism to prevent conflict during synchronization. A “conflict” generally refers to a disagreement or incompatibility that occurs between medical images and data during synchronization. The cloud-based PACS in accordance with one or more embodiments enables all healthcare facilities that are given permission to access a cloud data repository or database (“cloud repository”), such as facilities within the same hospital group, to share medical images and data. The medical images and data may also include a patient's medical reports. For example, a healthcare facility would be able to access and retrieve its patients' medical images and data obtained at the other healthcare facilities that are “in-network” (i.e., having permission to access the same portion of the cloud repository). Specifically, according to one or more embodiments, in-network healthcare facilities can more effectively utilize cloud-based PACS to share and update medical images and data for patients who frequent more one or more of the in-network healthcare facilities.

Moreover, unlike conventional cloud-based PACS, one or more embodiments of the invention enable a healthcare facility that utilizes cloud-based PACS to remain operational even when a network connection between the healthcare facility and the cloud is disconnected. Specifically, in-network healthcare facilities that utilize one or more embodiments are able to automatically keep on-site or local data repositories or databases (“local repositories”) updated with the most recent patient images and data stored in the cloud repository based on a need of the users of the cloud-based PACS (e.g., healthcare professionals). For example, if one facility updates or obtains a new medical image of a particular patient, the cloud repository may be automatically updated with the updated or new medical image, and all the local repositories of the in-network facilities that treat or care for that same patient may be automatically synchronized with the cloud repository. In one example implementation of one or more embodiments, when a healthcare facility is connected to the cloud, the users at the healthcare facility directly access and edit the medical images and data in the cloud repository, and a switch to accessing the local repository only occurs in the event that the connection between the healthcare facility and the cloud is disconnected.

In one or more embodiments, in the event that a connection between one of the in-network healthcare facilities and the cloud is disconnected and the local servers at the disconnected facility switch to working off the local repository, a restriction is placed on the disconnected facility with respect to the editing that can be performed on the local repository. The local servers at the disconnected facilities are restricted to only the addition of new local data to the local repository and prohibited from the editing and updating of existing local data. This enables the prevention of a potential conflict that may occur when the disconnected facility reconnects to the cloud and automatically synchronizes all of the local data to the cloud. For example, in one example implementation of one or more embodiments, because the medical images and data in the cloud repository are directly edited when a user initializes a web-browser based application associated with the cloud-based PACS, a conflict may occur between the medical images and data edited in the cloud repository and the medical images and data edited in the local repositories while the facility was disconnected from the cloud.

In one or more embodiments, if the local servers at an in-network healthcare facility determine that a user at a different in-network healthcare facility is locally editing a medical data that corresponds to a local data stored in the local repository, the local servers will place a restriction on the editing that can be performed on that specific local data. This enables the prevention of a potential conflict that may occur when two different edited versions of the same medical data gets uploaded to the cloud after users at different in-network healthcare facilities update information in the respective local data. For example, when two different edited versions of the same medical data get uploaded to the cloud, in certain situations, the cloud may not be able to determine which of the two edited data contains correct information.

In one or more embodiments, in the event of a loss of connection, the disconnected healthcare facilities automatically switch access to the local repositories instead of the cloud repository. This enables the healthcare facilities to establish a continuous workflow without experiencing any downtime caused by the disconnection from the network. Because the local repositories of in-network facilities are synchronized with the cloud repository, the facilities are able to at least temporarily access and work with the most up-to-date data, even without connection to the cloud. However, not all the data on the cloud repository need necessarily be synchronized. In one or more embodiments, the synchronization occurs only with respect to data that is necessary or is of interest to the respective facilities. For example, a facility may not want its local repository filled or local server burdened with medical images related to people who are not patients of that facility.

In one or more embodiments, when the connection is reestablished, the medical images and data stored in the local repositories during the time of network disconnection are automatically uploaded to the cloud repository. This enables all of the other in-network healthcare facilities to update their respective local repositories with the most up-to-date medical images and data.

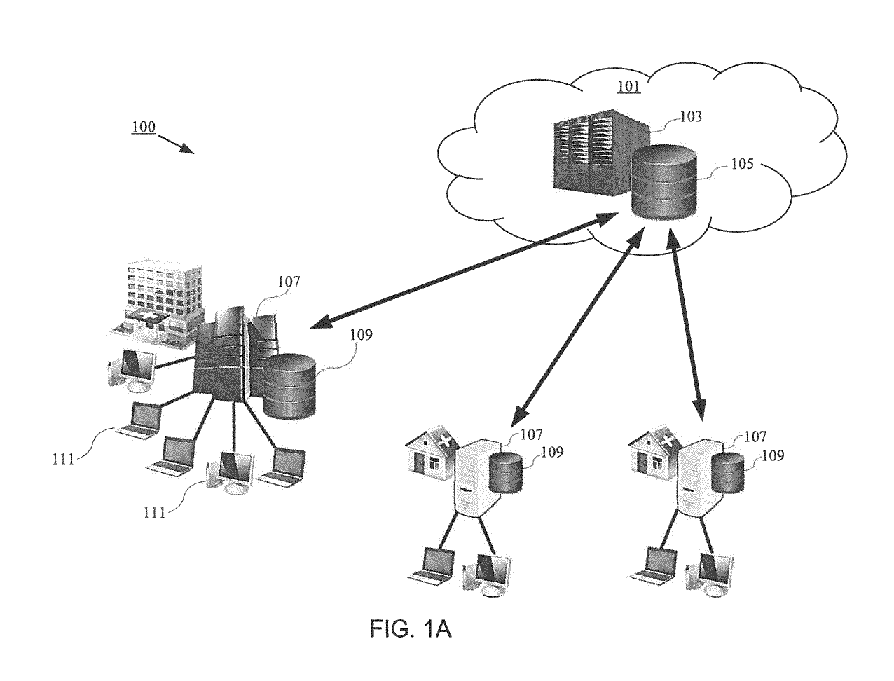

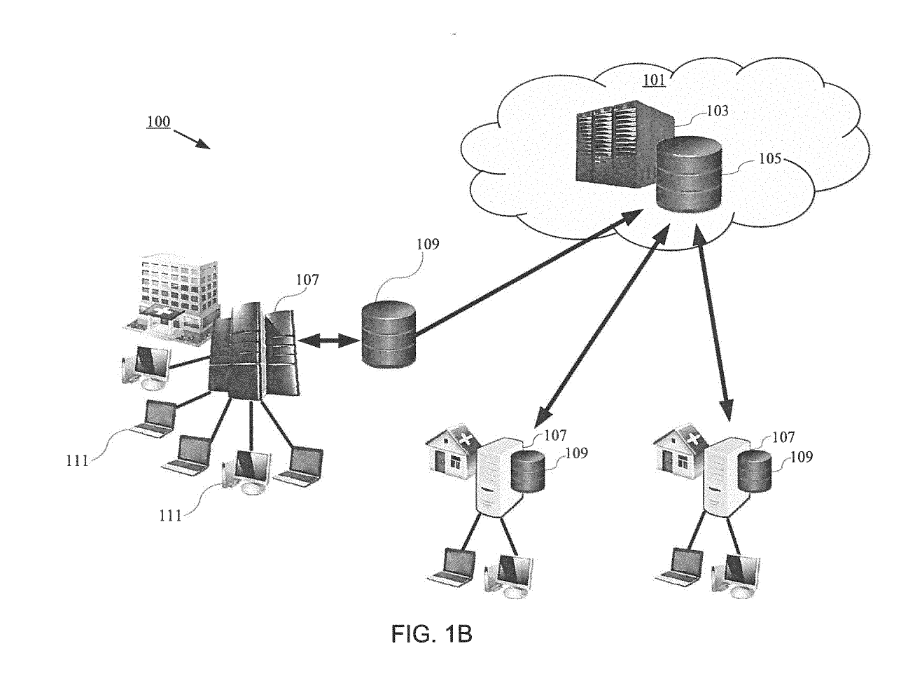

FIGS. 1A and 1B show a system (100) in accordance with one or more embodiments of the invention. As shown in FIGS. 1A and 1B, the system (100) includes a cloud (101) that includes a cloud server (103) with a cloud repository (105), and multiple local servers (107) (e.g., application proxy servers (APS)) and local repositories (109) associated with different in-network healthcare facilities (not labeled). The multiple local servers (107) are authorized to access/view the cloud server (103). In addition to the right to access the remote data on the cloud server (103), certain local servers (107) may also have the right to edit the remote data. Each of the healthcare facilities may be a type of facility that provides medical care such as a public hospital, a private hospital, a medical clinic, a dental clinic, etc.

As also shown in FIGS. 1A and 1B, each healthcare facility in the system (100) includes multiple user computing devices (111) (herein referred to as “a local computer”) coupled to the local servers (107). Each local computer (111) may correspond to a personal computer (PC), a laptop, a mobile computing device (e.g., tablet PC, smartphone, etc.), a server, a mainframe, a kiosk, etc.

In one or more embodiments, the cloud server (103) with the cloud repository (105) may be operated by a vendor providing the cloud-based PACS or another third-party associated with such a vendor. In one or more embodiments, the cloud server (103) is a physical and/or virtual computing infrastructure that performs application and information processing. For example, the cloud server (103) may be a virtual server or a physical server accessed remotely via the Internet. In one or more embodiments, the cloud repository (105) is an online repository of data. For example, the cloud repository may be a virtual data room (VDR) or a database (or group of databases) accessed remotely via the Internet.

In one or more embodiments, the cloud server (103) is configured to receive the medical images and data transmitted from the local servers (107) and store the medical images and data in the cloud repository (105) as remote data.

In one or more embodiments, each local server (107) is operated by the associated healthcare facility. The local server (107) is configured to transmit the medical images and data received from the local computers (111) to the cloud repository (105) on the cloud server (103). Each local repository (109) is operated and maintained by the associated healthcare facility. The local repository (109) may locally store medical images and data received from the local server (107) and the cloud repository (105) local data.

In one or more embodiments, the local computers (111) are operated by medical professionals associated with the respective healthcare facilities and are configured to transmit to the local server (107) medical images and data taken from one or more modalities (not shown) in the healthcare facility. In one or more embodiments, the local computers (111) may be configured as the local server (107). In one or more embodiments, the local computers (111) may also include the local repository (109).

In one or more embodiments, the local computers are configured to store an application provided by the vendor that operates the cloud (101). In one or more embodiments, the application may be provided by a third-party associated with the vendor. The application may be an independent software application or a web-browser based application with a graphical user interface (“GUI”) that allows the local computers (111) to access the cloud (101).

FIG. 1A shows an example in accordance with one or more embodiments where the connection between the in-network healthcare facilities and the cloud (101) is stable. In this state, the multiple in-network healthcare facilities may communicate bilaterally with the cloud (101). As shown in FIG. 1A, the in-network healthcare facilities may transmit locally-obtained medical images and data to the cloud (101) to be stored as remote data in the cloud repository (105) accessible to other in-network healthcare facilities. In one or more embodiments, the in-network healthcare facilities may retrieve medical images and data from the cloud (101) to be stored as local data in their respective local repositories (109).

In one or more embodiments, not all of the remote data stored in the cloud repository (105) need be retrieved by the in-network healthcare facilities to be stored as local data. The remote data to be retrieved and stored as local data may vary based on the size and need of the healthcare facility or on the preferences of the local computers (111) (e.g., healthcare professionals). For example, the remote data to be retrieved and stored as local data in the local repositories (109) of certain in-network healthcare facilities may be based on specific individuals who are patients of those facilities. Thus, if a particular individual is not a patient of a particular in-network healthcare facility, that healthcare facility may not retrieve and store that patient's medical images and data from the cloud (101) as local data. This option may be particularly useful for smaller healthcare facilities with smaller local servers (107) and local repositories (109) with limited storage and processing power. In one or more embodiments, the remote data to be retrieved and stored as local data in the local repositories (109) of certain in-network healthcare facilities may be based on a specific medical study, medical series, medical image, or medical report instead of being based on specific individuals who are patients of those facilities.

In one or more embodiments, users of the local computers (111) at each in-network healthcare facility may view the medical images and data stored on the cloud repository (105) through a web-browser based version of the application that is stored on the cloud sever (103). The user may also view the images through a local version of the application stored on the local computers (111). For example, healthcare professionals may determine if any of the local data stored in the local repository (109) has been updated by another healthcare professional associated with a different in-network healthcare facility, and retrieve the updated data from the cloud repository (105) to replace the current local data. In one or more embodiments, the updating of the local data may be performed automatically by the system (100), e.g., through the application stored on the local computers (111).

For example, an individual may be a patient at multiple in-network healthcare facilities. Each of these in-network healthcare facilities may store the individual's medical images and data as local data. In one or more embodiments, the individual's medical images and data are updated in the cloud repository (105) by one of the in-network healthcare facilities, the other in-network healthcare facilities where the individual is also a patient may automatically retrieve (synchronize) the individual's updated images and data to keep the local data in the local repository (109) up-to-date. The automatic updating of the cloud repository (105) and/or synchronization of the pertinent local repositories (109) may be triggered every time the individual's medical images or data are updated on the cloud, or may be triggered at predetermined intervals.

FIG. 1B shows an example in accordance with one or more embodiments where a connection between one of the in-network healthcare facilities and the cloud (101) is disconnected. In this state, the application may automatically configure the local computers (111) and local servers (107) at the disconnected healthcare facility to access the local data stored in the local repository (109). In one or more embodiments, the disconnected healthcare facility continues to store into the local repository (109) medical images and data taken or updated during the time of disconnection. This enables the disconnected healthcare facility to establish a continuous workflow without experiencing any downtime caused by the disconnection from the cloud (101).

Then, when the connection between the disconnected healthcare facility is reestablished with the cloud (101), the local computers (111) and local servers (107) of the reconnected healthcare facility may be configured by the application to transmit to the cloud (101) all of the medical images and data stored in the local repository taken or updated during the time of disconnection. Such medical images and data may then be stored in the cloud repository (105) as new remote data. As the cloud (101) is being updated with the medical images and data from the reconnected healthcare facility, the application stored in the local computers (111) of the other in-network facilities may automatically update their respective local repositories (109) with the new remote data.

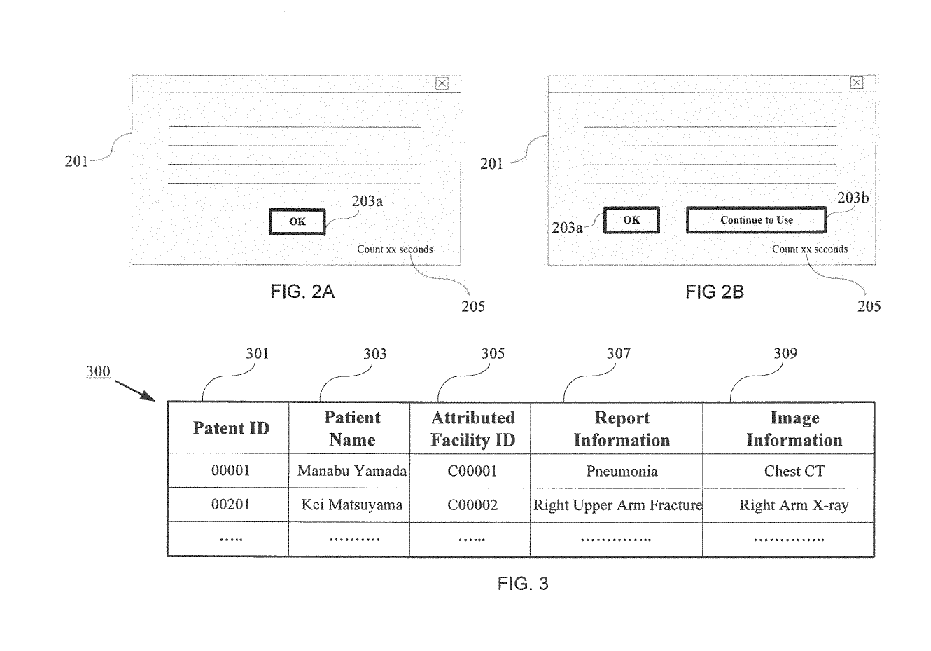

FIGS. 2A and 2B show a display message (201) in accordance with one or more embodiments, which may be displayed as part of a pop-up window by the application on the local computer (111) for its user. In this example, the display message (201) includes a user-selectable tab (203a and 203b) (e.g., selectable by the user with a click of a mouse) and a countdown timer (205). The display message (201) may appear as a pop-up window on a display of the local computer (111). The display message (201) may contain a message related to the current connection status between the local severs (107) of the in-network healthcare facilities and the cloud server (103).

FIG. 2A shows an example of the display message (201) when the connection between a local sever (107) of one of the in-network healthcare facilities and the cloud server (103) is disconnected. The display message (201) would include a message that indicates that the connection to the cloud (101) has been disconnected and that the local computer (111) will automatically access the local repository (109) when the countdown timer (205) runs out. Although a single local repository is used in certain descriptions herein for illustration purposes, the number of local computers and local repositories at each healthcare facility may vary.

In one or more embodiments, the users operating the local computer (111) may either wait for the countdown timer (205) to run out or directly click on the user-selectable tab (203a) to access the local repository (109) instead of the cloud repository (105) (i.e., switch access to the local repository (109)).

FIG. 2B shows an example of the display message (201) when the connection between a local sever (107) of one of the disconnected in-network healthcare facility and the cloud server (103) is reestablished. The display message (201) would include a message that indicates that the connection to the cloud (101) has been reestablished and prompts the user (e.g., healthcare professional) to choose between continuing to work off the local repository (109) or to re-access the cloud repository (105). In one or more embodiments, the application of the system (100) gives the user the option to work off the local repository only temporarily (e.g., for a pre-set or predetermined time period). In such a case, as shown in the example of FIG. 2B, the display message (201) may further include a message indicating that the local computer (111) would automatically re-access the cloud repository (105) when the countdown timer (205) runs out (i.e., switch access back to the cloud repository (105)).

Still referring to FIG. 2B, in one or more embodiments, the user may either select user-selectable tab (203a) to immediately re-access the network repository (105) or select user-selectable tab (203b) to continue to work locally off the local repository (109). Again, in this example, the continued use of the local repository after the connection with the cloud has been reestablished is limited. Once the pre-set time period has expired, the user would be prompted with another display message (201) to reconnect to the cloud (101).

FIG. 3 shows an example of a data table (300) that includes data associated with each medical image. In one or more embodiments, the data table (300) may include patient related information such as, but not limited to, a Patient ID (301), Patient Name (303), Attributed Facility ID (305), Report Information (307), and Image Information (309).

In one or more embodiments, the Patient ID (301) is an individual's patient identification number. Each individual will have a single unique Patient ID (301). The individual's Patient ID (301) is shared among the in-network healthcare facilities. The Patient Name (303) is the legal name of the individual.

In one or more embodiments, the Attributed Facility ID (305) may be the identification number of the in-network healthcare facility where the individual is a patient (e.g., the in-network healthcare facility associated with the individual). If an individual frequents more than one of the multiple in-network healthcare facilities, the individual will be associated with more than one Attributed Facility ID (305). Alternatively, in one or more embodiments, the Attributed Facility ID (305) may be the identification number of the in-network healthcare facility that obtained the first image of the particular patient uploaded onto the cloud (101), in which case the patient will have no more than one Attributed Facility ID (305). In one or more embodiments, the Attributed Facility ID may be assigned directly by a user at an in-network healthcare facility (i.e., a healthcare professional).

In one or more embodiments, the Report Information (307) includes information on the individual's medical diagnosis. The Image Information (309) includes a brief description of the medical image and the name of the modality used to generate the medical image.

In one or more embodiments, the data in data table (300) is embedded as metadata in the medical image, which may be a Digital Imaging and Communications in Medicine Format (DICOM-format) image. In one or more embodiments, DICOM may be the universal image format for implementing the system (100). The data from the table (300) can be extracted from the DICOM-format images using the application of one or more embodiments stored in the local computers (111). In one or more embodiments, the data in data table (300) may also be directly imbedded as metadata in the medical data, which can be either the patient's medical images or a patient's medical report.

The data in the table (300) may be sorted in any number of ways. In the example shown FIG. 3, the data is sorted by patient. However, the data can be sorted another way using any one of the patient related information based, for example, on the preferences of the healthcare professionals. Once the data from the data table (300) has been extracted from the medical image, healthcare professionals can edit/modify the data using the GUI provided with the application of one or more embodiments. In one or more embodiments, the extracted data table (300) is stored in the local servers (107).

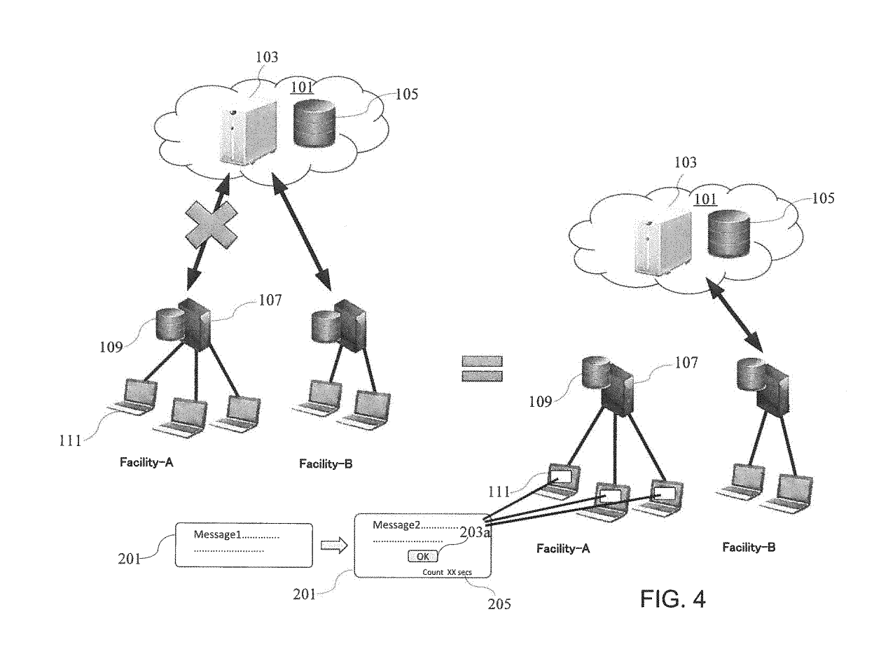

FIGS. 4-7 show different states of the system of FIGS. 1A and 1B in accordance with one or more embodiments. The cloud (101), the cloud server (103), the cloud repository (105), the local servers (107), the local repository (109), the local computers (111), the display message (201), the user selectable tab(s) (203a and 203b), and the countdown timer (205) may be identical or substantially similar as described above with respect to FIGS. 1, 2A, and 2B. Detailed descriptions of such like components will not be repeated below.

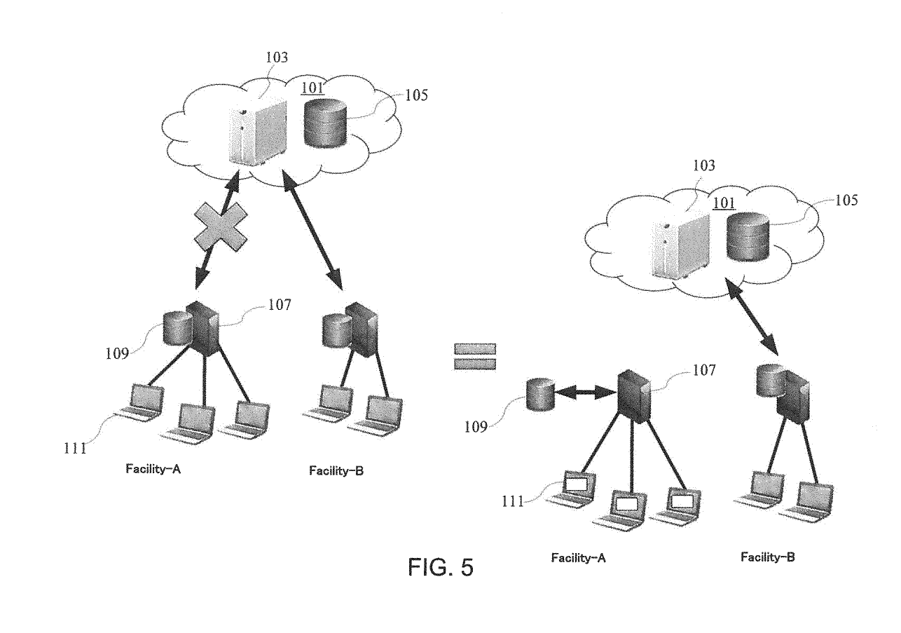

FIGS. 4 and 5 each show a state where a connection between a healthcare facility among the multiple in-network healthcare facilities and the cloud (101) gets disconnected. In this case, as shown on the right-hand side of FIG. 4, the local computers (111) associated with the disconnected healthcare facility may first display the display message (201) to indicate that the connection to the cloud (101) is disconnected. The display message (201) may then prompt the user to switch access from the cloud repository (105) to the local repository (109) of the disconnected healthcare facility by selecting the user selectable tab (203a). Additionally or alternatively, the display message (201) may show the user the countdown timer (205) so that the switch will occur automatically once the timer has run out. The right-hand side of FIG. 5 shows the local computers (111) and local servers (107) associated with the disconnected healthcare facility has switched access from the cloud repository (105) to the local repository (109).

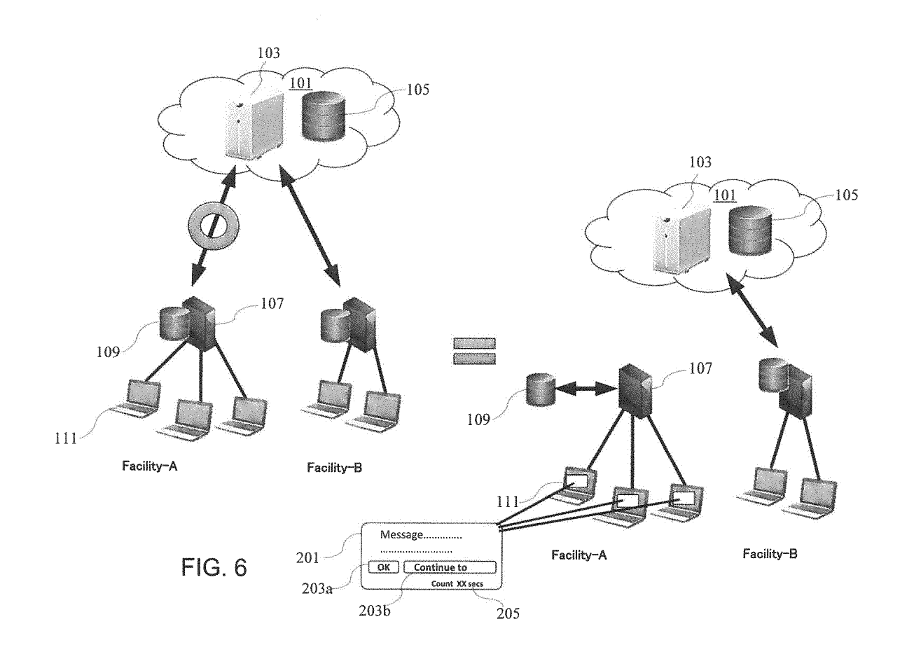

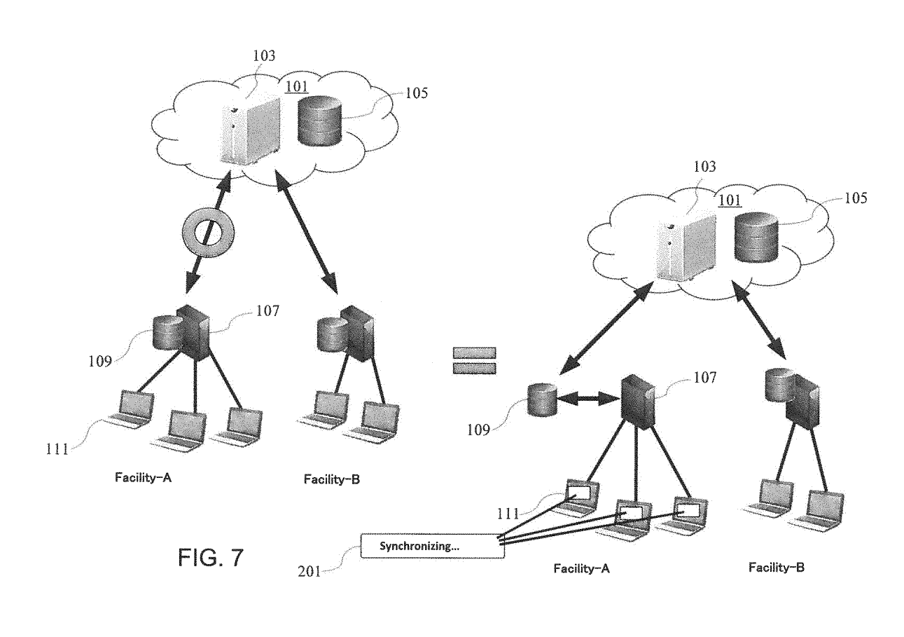

FIGS. 6 and 7 each show a state where a connection is reestablished between the disconnected healthcare facility and the cloud (101). In this case, as shown on the right-hand side of FIG. 6, the local computers (111) associated with the re-connected healthcare facility may first display the display message (201) to indicate that the connection to the cloud (101) is re-connected. The display message (201) may then prompt the user to choose between re-accessing the cloud repository (105) (by selecting the user selectable tab (203a)) or continuing to work locally (by selecting the user selectable tab (203b)). Additionally or alternatively, the display message (201) may show the user the countdown timer (205) so that the re-accessing (i.e., switching access from the local repository (109) back to the cloud repository (105)) will occur automatically once the timer has run out. The right-hand side of FIG. 7 shows the local computers (111) associated with the re-connected healthcare facility displaying the display message (201) to indicate that the data stored in the local repository (109) during the time of disconnection is being transmitted to the cloud repository (105), and that the cloud repository (105) is synchronizing with the local repository (109).

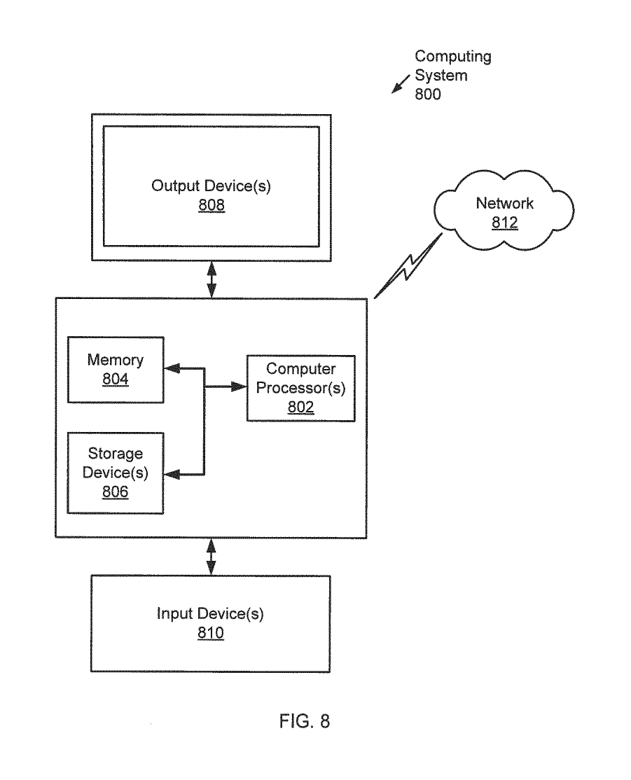

Embodiments of the invention may be implemented on virtually any type of computing system, regardless of the platform being used. For example, the computing system may be one or more mobile devices (e.g., laptop computer, smart phone, personal digital assistant, tablet computer, or other mobile device), desktop computers, servers, blades in a server chassis, or any other type of computing device or devices that includes at least the minimum processing power, memory, and input and output device(s) to perform one or more embodiments of the invention. For example, as shown in FIG. 8, the computing system (800) may include one or more computer processor(s) (802), associated memory (804) (e.g., random access memory (RAM), cache memory, flash memory, etc.), one or more storage device(s) (806) (e.g., a hard disk, an optical drive such as a compact disk (CD) drive or digital versatile disk (DVD) drive, a flash memory stick, etc.), and numerous other elements and functionalities. The computer processor(s) (802) may be an integrated circuit for processing instructions. For example, the computer processor(s) may be one or more cores, or micro-cores of a processor. The computing system (800) may also include one or more input device(s) (810), such as a touchscreen, keyboard, mouse, microphone, touchpad, electronic pen, or any other type of input device. Further, the computing system (800) may include one or more output device(s) (808), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device(s). The computing system (800) may be connected to a network (812) (e.g., a local area network (LAN), a wide area network (WAN) such as the Internet, mobile network, or any other type of network) via a network interface connection (not shown). The input and output device(s) may be locally or remotely (e.g., via the network (812)) connected to the computer processor(s) (802), memory (804), and storage device(s) (806). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments of the invention.

Further, one or more elements of the aforementioned computing system (800) may be located at a remote location and connected to the other elements over a network (812). Further, one or more embodiments of the invention may be implemented on a distributed system having a plurality of nodes, where each portion of the invention may be located on a different node within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

The computing system of FIG. 8 may include functionality to present raw and/or processed data, such as results of comparisons and other processing. For example, presenting data may be accomplished through various presenting methods. Specifically, data may be presented through a user interface provided by a computing device. The user interface may include a GUI that displays information on a display device, such as a computer monitor or a touchscreen on a handheld computer device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

For example, a GUI may first obtain a notification from a software application requesting that a particular data object be presented within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

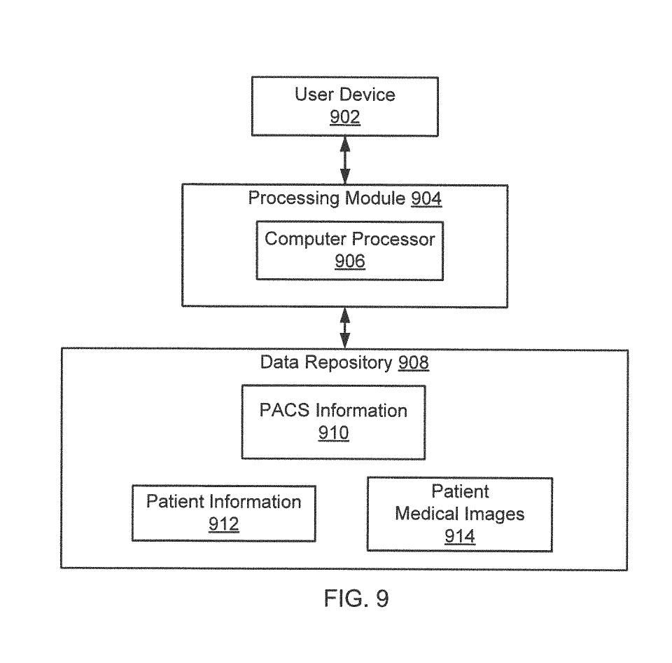

FIG. 9 shows a schematic diagram of a system in accordance with one or more embodiments. The system is configured for prevention of conflict during synchronization of medical data between a cloud repository on a cloud server and a plurality of local repositories on a plurality of local servers connected to the cloud server. The plurality of local servers includes a first local server and the plurality of local repositories includes a first local repository on the first local server. As explained above, the use of ordinal numbers does not imply or create a particular ordering of the elements or limit any element to being only a single element. For example, the “first local server” may be any local server among the plurality of local servers connected to the cloud server, and is merely called “first” for purposes of illustration.

The system as shown in FIG. 9 may include, for example, (i) a processing module (904) including a computer processor (906) configured to execute instructions configured to perform the following steps based on the connection status between the first local server and the cloud server.

In one aspect, while a connection between the first local server and the cloud server is established, the computer processor (906) executes instructions to cause the first local server to (1) receive, from the cloud repository, remote data sent from any of the plurality of local servers to the cloud repository, (2) store the remote data in the first local repository as local data, and (3) if the first local server determines that the remote data is being updated by any of the plurality of local servers, restrict an editing that can be performed on the local data.

In another aspect in response to the connection between the first local server and the cloud server getting disconnected, the computer processor (906) executes instructions to cause the first local server to access the first local repository instead of the cloud repository, and restrict editing on the first local repository.

The system as shown in FIG. 9 further comprises (ii) a user device (902) configured to present the medical images and data to a user. The system may further include a data repository (908) configured to store PACS application data (i.e., PACS information) (910) related to the vendor provided application, the patient information (912), and the medical images and data (914).

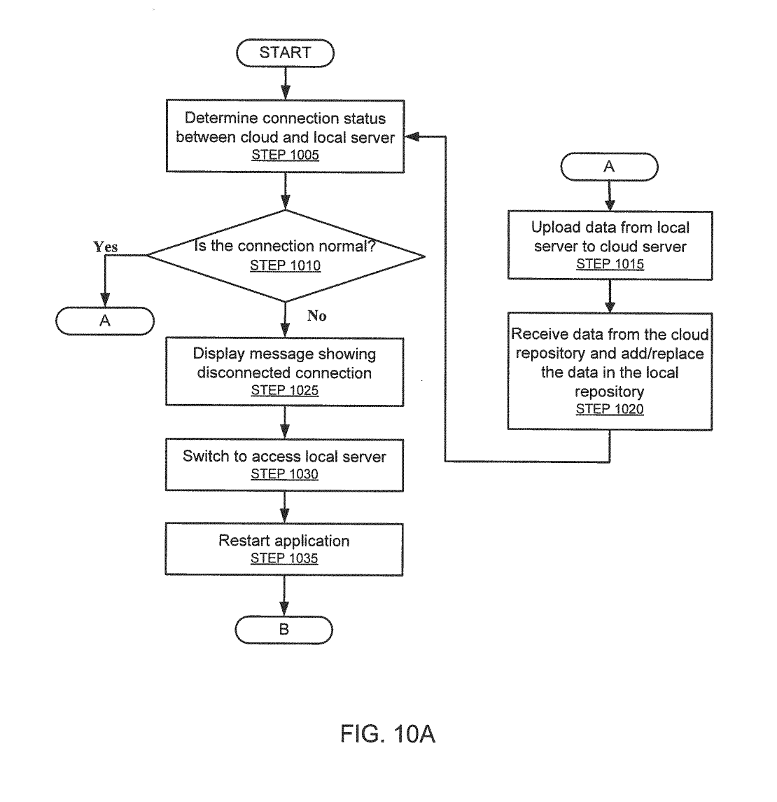

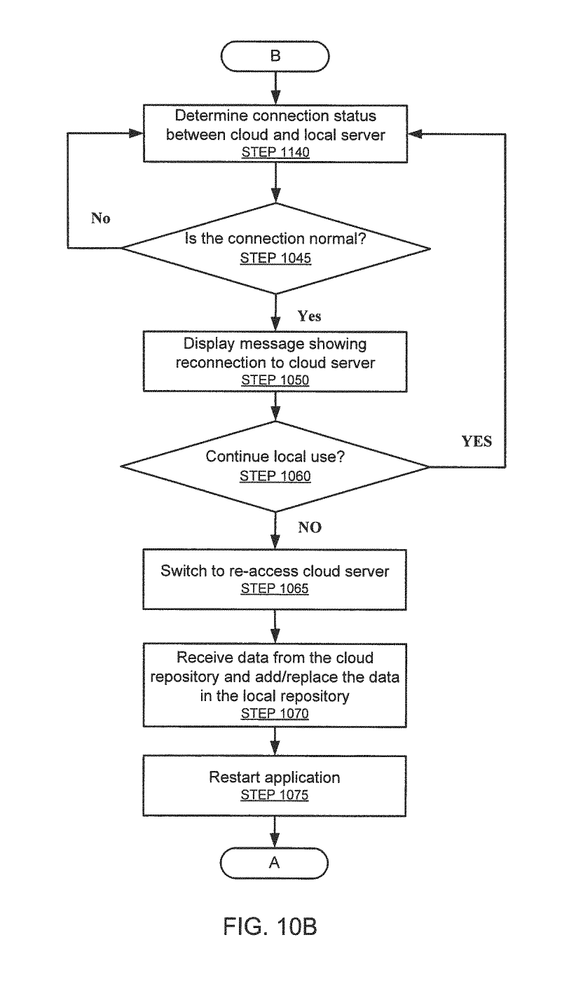

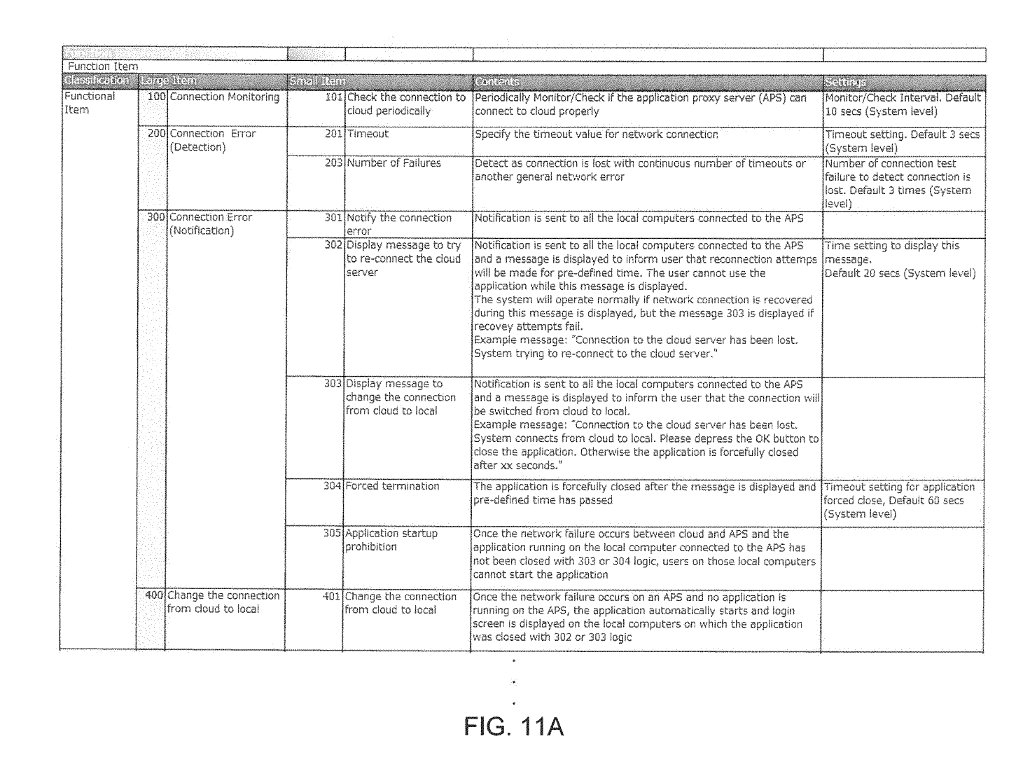

FIGS. 10A and 10B shows a flowchart of a method in accordance with one or more embodiments. In one or more embodiments, the method as shown in FIGS. 10A and 10B is a computer-implemented method. Each step shown in FIGS. 10A and 10B are described together below with respect to only a system of one healthcare facility among the multiple in-network healthcare facilities. It would be apparent to one of ordinary skill in the art that each step of the method described below can be performed by any of the systems of the multiple in-network healthcare facilities.

In Steps 1005 and 1010, the local computers associated with one of the in-network healthcare facilities check the status of the connection between the local servers of the healthcare facility and the cloud server on the cloud to determine if the connection is normal.

If the result of the check in Step 1010 is YES, the local computers continue to upload data generated by the modalities to the cloud server through the local servers in Step 1015, and synchronize a data between the local repositories and the cloud repository in Step 1020. The process then returns to Step 1005.

In one more embodiments, in response to the cloud server being updated in Step 1015, the local computers and servers of the other in-network facilities will receive either all or part of the updated data from the cloud server. When the local computers and servers of the in-network facilities receive the updated data, the respective local computers and servers will either add the updated data to the respective local repositories if the updated data did not previously exist, or replace pre-existing locally-stored data that corresponds to the updated data with the updated data.

If the result of the check in Step 1010 is NO, a message is displayed in Step 1025 to the user indicating that the connection between the healthcare facility and the cloud is disconnected, and that the local computers and servers will be switching access to the local repository (or repositories).

In Step 1030, the local computers and servers of the disconnected healthcare facility switch access to the local repository, and, in Step 1035, an application stored on the local computers and servers that enable the local computers and servers to access the cloud is restarted. At this point, the medical images and data are being stored and retrieved from the local repository instead of from the cloud repository.

In one or more embodiments, when the message is displayed to the users, the users can either click on a user-selectable tab to instantly switch access to the local repository or wait for the local computers and servers to automatically switch access to the local repository when a countdown timer displayed on the message to run out.

In Steps 1040 and 1045, once the application has been restarted, the local computers of the disconnected healthcare facilities perform a check to determine if there is a normal connection between the local servers and the cloud server.

If the result of the check is NO, the local computers and servers continue to operate locally and the process returns to Steps 1040 and 1045 where the local computers check the status of the connection between the local server and the cloud server.

If the result of the check is YES, a message is displayed in Step 1050 to the users indicating that the connection between the healthcare facility and the cloud has been reestablished, and that the local computers and servers are switching access back to the remote repository.

In Step 1060, when the message is displayed to the users, the users are prompted to make a determination if the users want to continue to work locally off the local repository. The local computers and servers will automatically re-access the cloud server if a response by the users is not detected by the time a countdown timer on the message runs out.

If the result of the check is YES, the local computers and servers remain on the local connection for a pre-set period where the local computer continues to check the connection status between the local servers and the cloud server in Step 1040. Once the pre-set time period has expired, the user would be prompted with another display message to reconnect to the cloud. This time, the user would not be able to choose to continue to work locally off the local repository.

If the result of the check is NO, the local computers and servers are configured to re-access the cloud repository in Step 1065.

Then, in Step 1070, when the local computers and servers have re-accessed the cloud repository, the cloud repository is synchronized, i.e., updated with data stored in the local repository during the time of reconnection along with new data that was generated after the reconnection with the cloud server. In the event a conflict has occurred during the disconnection (e.g., when more than one user at different in-network healthcare facilities attempts to simultaneously update the patient information associated with the same remote data on the remote server), the conflict may be resolved automatically by the application or manually by the user through a GUI provided by the application.

In one or more embodiments, a conflict may occur when local data from the local servers of the in-network healthcare facilities are being uploaded to the cloud server (e.g., during medical data synchronization between the respective local servers and the cloud server). The conflict may occur when different users at different in-network healthcare facilities attempt to simultaneously update the same portion of the patient information of the same remote data by editing or updating the information locally in the corresponding local data. This may prevent the application from determining which of the updated patient information is correct when the cloud server tries to update the remote data using the information from the two received edited local data.

More specifically, in one or more embodiments, certain conflict situations may be more complex than others. For example, if a user at in-network healthcare facility A updates a patient name from “AAAAA” to “AAABA” and a user at a different in-network healthcare facility updates the same patient name from “AAAAA” to “AAACA,” when the two users attempt to simultaneously update the same remote data to reflect the new patient name, the system will be unable to determine which of the two new names is correct. In this case, the user must manually resolve the conflict. However, if the user at in-network health care facility A edits a patient name from “AAAAA,” to “AAABA,” and a user at in-network healthcare facility B edits the same patient name from “AAAAA,” to “ACAAA,” then, when the two users attempt to simultaneously update the same remote data to reflect the new patient name, the application will be able to automatically update the patient name to “ACABA.”

Further, the local computers and servers of the disconnected healthcare facility will receive data from the cloud server updated by the other in-network healthcare facilities during the time of disconnection and either add the updated data to the local repository if the updated data did not previously exist, or replace pre-existing locally-stored data that corresponds to the updated data with the updated data.

In one or more embodiments, in response to the cloud server being updated in Step 1070, the local computers and servers of the other in-network facilities will receive either all or part of the updated data from the cloud server. When the local computers and servers of the in-network facilities receive the updated data, the respective local computers and servers will either add the updated data to the respective local repositories if the updated data did not previously exist, or replace pre-existing locally-stored data that corresponds to the updated data with the updated data.

In Step 1075, when all of the data stored in the local repository during the time of reconnection is transmitted to the cloud repository, the application is restarted and local computers are configured to return to Step 1005.

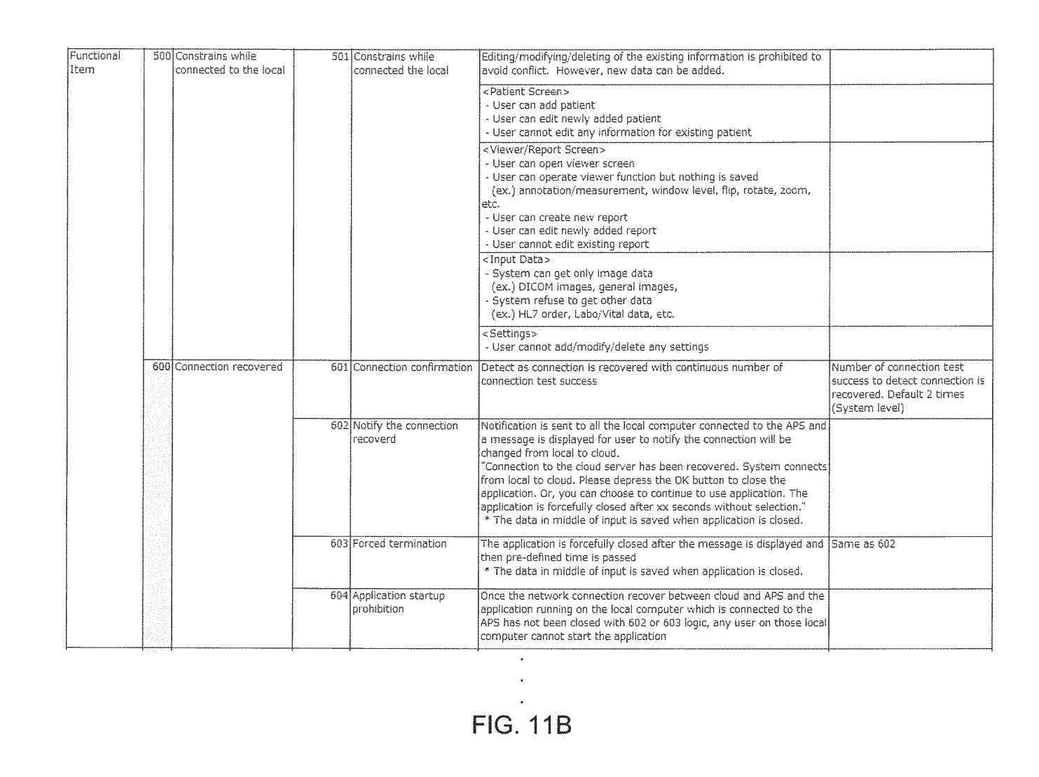

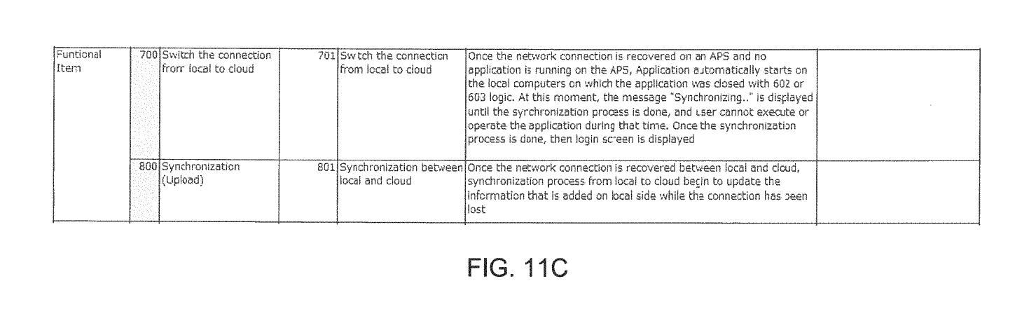

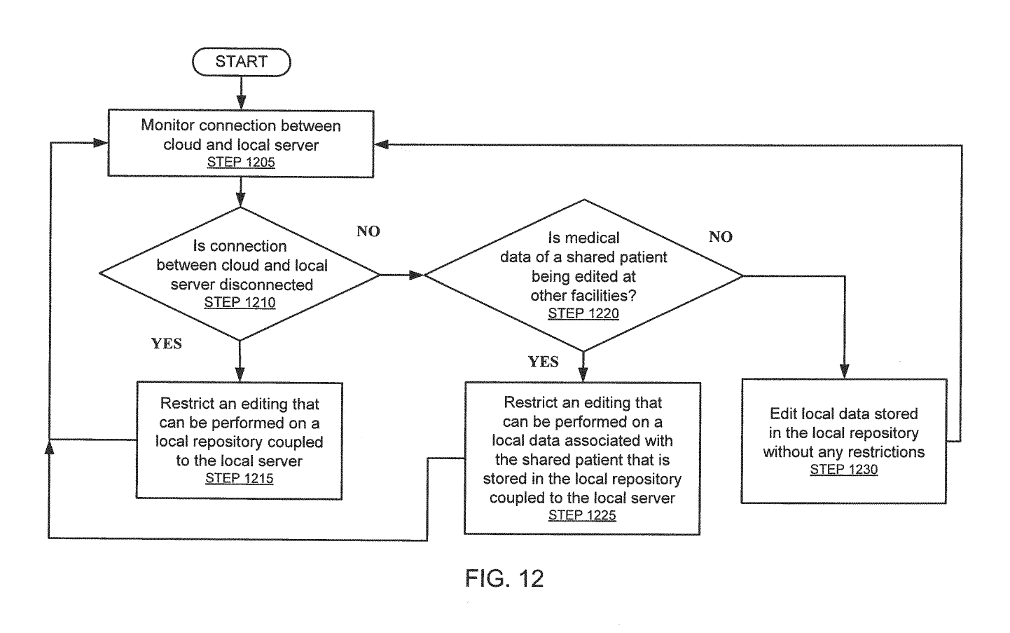

FIGS. 11A, 11B, and 11C show an implementation example in accordance with one or more embodiments. As shown in FIGS. 11A, 11B, and 11C each of the functional items is broken down into a large item (“a top-level function”) and multiple small items (“sub-functions of the top-level functions”). The top-level functions and the sub-functions are implemented by a user or a respective component of the system shown in FIGS. 1A and 1B during each step of the flowchart as shown in FIGS. 10A, 10B, and 12.

According to one or more embodiments, the contents of each sub-function describe the actions that can be implemented by the user or the respective components of the system shown in FIGS. 1A and 1B when each sub-function is being implemented. The actions also show the actions that cannot be implemented by the user when a specific sub-function is being implemented.

According to one or more embodiments, the settings describe a user-set interval or amount of time associated with specific sub-functions that may be repeated or set with a specific time restriction when implemented. The settings may be non-configurable settings that are pre-set by the vendor that provides the application. Further, the settings may be user-configurable settings that can be configured by a user with high administrative authority in the healthcare facility.

FIG. 12 shows a flowchart of a method in accordance with one or more embodiments. The method as shown in FIG. 12 may be a computer-implemented method. Each step shown in FIG. 12 is described together below with respect to only a system of one healthcare facility among the multiple in-network healthcare facilities. It would be apparent to one of ordinary skill in the art that each step of the method described below can be performed by any of the systems of the multiple in-network healthcare facilities.

In Steps 1205, the local computers associated with one of the in-network healthcare facilities monitors the status of the connection between the local servers of the healthcare facility and the cloud server on the cloud.

In Step 1210, the local computers determine whether the connection between the local servers and the cloud server has been disconnected.

If the result of the determination in Step 1210 is YES (i.e., there is no network connection between the local servers and cloud), the local computers place a restriction in Step 1215 on the editing that can be performed on a local repository coupled to the local server.

In one or more embodiments, when a restriction is placed on the editing that can be performed on a local repository, the existing data stored in the local repository as local data cannot be edited or modified by the users at the disconnected healthcare facility (e.g., the healthcare professionals). In one or more embodiments, the local computers only allow the users at the disconnected healthcare facility to add medical data to the local repository as new medical data. The new medical data may be associated with an existing patient or a new patient.

If the result of the determination in Step 1210 is NO (i.e., the connection between the local servers and the cloud server is normal), the local computers determine in Step 1220 is a medical data of a shared patient is being edited at a different in-network healthcare facility.

In one or more embodiments, the medical data of a shared patient may be a medical data for a predetermined patient that was received as a remote data from a different in-network healthcare facility through the cloud server and stored locally as a local data. In one or more embodiments, the medical data of the shared patient may be associated with a local medical data that was transmitted to the cloud server and retrieved by the local computers at a different in-network healthcare facility to be stored as local data at that in-network healthcare facility.

In one or more embodiments, when any of the in-network healthcare facilities edit a local data, the respective local computers will determine, using the information in the metadata of the local data, whether the local data being edited is also stored in a local repository of a different in-network healthcare facility (i.e., if the medical data is a shared medical data that is also available at another in-network healthcare facility). If it is determined that the local data being edited is a shared data, the local computers at the facility that is editing the shared data will transmit a notification to the cloud server to notify the local computers at the other facilities that the shared data is currently being edited.

If the result of the determination in Step 1220 is YES, the local computers place a restriction in Step 1215 on the editing that can be performed on an existing local data stored in the local repository that corresponds to the shared data that is being edited at a different facility.

In one or more embodiments, when a restriction is placed on the editing of the local data, the local data is prohibited from being modified or updated by the users of the local computers. In one or more embodiments, if the users want to add or update the restricted local data with new information, the user must create a new local data associated with the same patient to store the new information. This ensures that no two facilities among the in-network healthcare facilities are editing the same medical data at the same time. Specifically, if the same medical data is simultaneously edited or updated at two different facilities, then when the local computers at the two different facilities upload the data to the cloud server to update the remote data on the cloud server that corresponds to the edited medical data, a potential conflict may occur because the cloud server would not be able to determine which of the two edited medical data contains correct information.

If the result of the determination in Step 1220 is NO, the local computers do not place any restrictions on the editing that can be performed on the local repository and any existing local data stored in the local repository. In one or more embodiments, a restriction on the editing that can be performed by the user is not placed when the local computers confirm that no potential conflicts may occur when the user edits the local repository and any existing local data stored in the local repository.

One or more embodiments of the invention may have one or more of the following advantages: the ability to automatically share and update medical images and data between multiple healthcare facilities that are in-network; the ability to maintain all of the local repositories of all of the in-network healthcare facilities that serve the same individual up-to-date with the individual's most recent medical images and data; the ability to establish a continuous workflow at every in-network healthcare facility without experiencing any downtime caused by a disconnection of any of the in-network healthcare facility with the share cloud; the ability to select the medical images and data to be stored in the local repositories of the respective in-network healthcare facilities so that the healthcare facilities would not need to maintain a full-sized on-site data center, the ability to automatically detect when a potential conflict may occur when the in-network healthcare facilities update local medical data to be stored or updated in the cloud server so that conflict can be avoided; the ability to restrict an editing that can be performed on the local repository and the existing local data stored in the local repository at an in-network healthcare facility where potential conflict may occur so that conflict may be avoided when the facility uploads medical data to the cloud server, etc.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method to prevent conflict during synchronization of medical data between a cloud repository on a cloud server and a plurality of local repositories on a plurality of local servers of healthcare facilities connected to the cloud server, wherein the plurality of local servers comprises a first local server and the plurality of local repositories comprises a first local repository on the first local server, the method comprising:
while a connection between the first local server and the cloud server is established, causing the first local server to:
receive, from the cloud repository, remote data sent from any of the plurality of local servers to the cloud repository,
store the remote data in the first local repository as local data, and
if the first local server determines that the remote data is being updated by any of the plurality of local servers, restrict editing that can be performed on the local data; and
in response to the connection between the first local server and the cloud server getting disconnected, causing the first local server to:
access the first local repository instead of the cloud repository; and
restrict editing on the first local repository.

2. The method according to claim 1, wherein the method further comprising:
in response to the connection between the first local server and the cloud server getting reestablished, causing the first local server to:
re-access the cloud repository, and
if any local data on the first local repository was added by the first local server while the connection was disconnected, send the added local data to the cloud repository.

3. The method according to claim 2, wherein the first local repository is coupled to a local computer.

4. The method according to claim 1, wherein if the local data is being edited by the first local server, the first local server sends a notification to the cloud server to inform the plurality of local servers that store the remote data that the local data is being updated at the first local server.

5. The method according to claim 1, wherein
the editing of the local data is restricted to adding new information as new local data for a predetermined patient, and
the editing on the first local repository is restricted to adding new information as new local data associated with the predetermined patient or a new patient.

6. The method according to claim 5, wherein editing of existing local data in the first local repository is prohibited when editing is restricted.

7. The method according to claim 5, wherein the remote data and the local data are DICOM-format images or a patient's medical reports that includes metadata.

8. The method according to claim 7, wherein the metadata comprises a patient ID, a patient name, an attributed facility ID, a patient report information, and an image information.

9. The method according to claim 8, wherein the metadata is editable by a user through a graphical user interface (GUI) displayed by a computer coupled to the plurality of respective local servers.

10. The method according to claim 1, wherein the local repository is a repository disposed in a medical facility.

11. The method according to claim 7, wherein the DICOM-format images are taken using a modality in a medical facility connected to a computer coupled to the plurality of respective local servers.

12. The method according to claim 1, wherein the cloud repository on the cloud server is a repository for a cloud-based Picture Archiving and Communication System (PACS).

13. A non-transitory computer-readable medium (CRM) storing instructions that cause a first local server coupled to a computer to perform an operation to prevent conflict during synchronization of medical data between a cloud repository on a cloud server and a plurality of local repositories on a plurality of local servers of healthcare facilities connected to the cloud server, wherein the plurality of local servers comprises the first local server and the plurality of local repositories comprises a first local repository on the first local server, the operation comprising:
while a connection between the first local server and the cloud server is established, causing the first local server to:
receive, from the cloud repository, remote data sent from any of the plurality of local servers to the cloud repository,
store the remote data in the first local repository as local data, and
if the first local server determines that the remote data is being updated by any of the plurality of local servers, restrict editing that can be performed on the local data; and
in response to the connection between the first local server and the cloud server getting disconnected, causing the first local server to:
access the first local repository instead of the cloud repository; and
restrict editing on the first local repository.

14. The CRM according to claim 13, wherein the operation further comprising:
in response to the connection between the first local server and the cloud server getting reestablished, causing the first local server to:
re-access the cloud repository, and
if any local data on the first local repository was added by the first local server while the connection was disconnected, send the added local data to the cloud repository.

15. The CRM according to claim 13, wherein
the editing of the local data is restricted to adding new information as new local data for a predetermined patient, and
the editing on the first local repository is restricted to adding new information as new local data associated with the predetermined patient or a new patient.

16. The CRM according to claim 15, wherein editing of existing local data in the first local repository is prohibited when editing is restricted.

17. A system that prevents conflict during synchronization of medical data, comprising:
a cloud server;
a cloud repository on the cloud server; and
a plurality of local repositories on a plurality of local servers of healthcare facilities connected to the cloud server, wherein the plurality of local servers comprises a first local server and the plurality of local repositories comprises a first local repository on the first local server,
while a connection between the first local server and the cloud server is established, causing the first local server to:
receive, from the cloud repository, remote data sent from any of the plurality of local servers to the cloud repository,
store the remote data in the first local repository as local data, and
if the first local server determines that the remote data is being updated by any of the plurality of local servers, restrict editing that can be performed on the local data; and
in response to the connection between the first local server and the cloud server getting disconnected, causing the first local server to:
access the first local repository instead of the cloud repository, and
restrict editing on the first local repository.

18. The system according to claim 17, wherein
in response to the connection between the first local server and the cloud server getting reestablished, causing the first local server to:
re-access the cloud repository, and
if any local data on the first local repository was added by the first local server while the connection was disconnected, send the added local data to the cloud repository.

19. The system according to claim 17, wherein
the editing of the local data is restricted to adding new information as new local data for a predetermined patient, and
the editing on the first local repository is restricted to adding new information as new local data associated with the predetermined patient or a new patient.

20. The system according to claim 19, wherein editing of existing local data in the first local repository is prohibited when editing is restricted.
